(19) United States
(12) Patent Application Publication
(10) Pub. No.: US 2022/0407398 A1
(43) Pub. Date: Dec. 22, 2022

(54) ROTARY ELECTRIC MACHINE WITH PROGRAMMABLE INTERFACE

(71) Applicant: LCDRIVES CORP., Potsdam, NY (US)

(72) Inventors: Eric SCHUMAN, Albany, NY (US); David H. LEACH, West Hartford, CT (US); Matthew HONICKMAN, Potsdam, NY (US); Dylan BROOMFIELD, Gansevoort, NY (US); Eric M. FORREST, Clifton Park, NY (US); Russel H. MARVIN, Potsdam, NY (US)

(21) Appl. No.: 17/349,082

(22) Filed: Jun. 16, 2021

(51) Int. Cl. H02K 11/35; H02K 11/25; H02K 11/33; H02P 29/62

(52) U.S. Cl. CPC H02K 11/35; H02K 11/25; H02K 11/33; H02P 29/62

(57) ABSTRACT

One example includes a rotary electric machine. The device includes at least one sensor. Each of the at least one sensor can be configured to provide a sensor signal in a first data format, the sensor signal providing an indication of a respective one of a plurality of operational characteristics of the rotary electric machine. The device also includes a programmable interface configured to receive the sensor signal from each of the at least one sensor and to translate the first data format associated with each of the at least one sensor into a second data format associated with a respective type of sensor corresponding to the respective at least one sensor and to provide at least one output signal in the second data format. Each of the at least one output signal can correspond to at least one of the operational characteristics.

### TECHNICAL FIELD

The present description relates generally to electronic circuits, and specifically to a rotary electric machine with a programmable interface.

### BACKGROUND

Rotary electric machines such as motor devices or generators are typically controlled by electronic motor drives that can provide sophisticated control of the rotary electric machine. As an example, motor drives can control operational parameters such as speed and position of rotary electric machines. Motor drives and associated logic controllers can also be configured to operate the rotary electric machine based on operational characteristics of the rotary electric machine. For example, exterior sensors can be installed to rotary electric machines to provide a measure of the operational characteristics of the motor, such as position (e.g., via encoders), speed, temperature (e.g., via environment sensors), or any of a variety of other parameters. Such sensors can be provided external to the rotary electric machine, and can thus be susceptible to damage and to errors resulting from exterior positioning. Furthermore, such sensors provide a specific type of output data format that requires the motor drive or the logic controller to be compatible with the output data format.

### SUMMARY

One example includes a rotary electric machine. The device includes at least one sensor. Each of the at least one sensor can be configured to provide a sensor signal in a first data format, the sensor signal providing an indication of a respective one of a plurality of operational characteristics of the rotary electric machine. The device also includes a programmable interface configured to receive the sensor signal from each of the at least one sensor and to translate the first data format associated with each of the at least one sensor into a second data format associated with a respective type of sensor corresponding to the respective at least one sensor and to provide at least one output signal in the second data format. Each of the at least one output signal can correspond to at least one of the operational characteristics.

Another example includes a rotary electric machine. The device includes at least one sensor. Each of the at least one sensor can be configured to provide a sensor signal providing an indication of a respective one of a plurality of operational characteristics of the rotary electric machine. The device also includes a programmable interface comprising a non-volatile memory. The programmable interface can be configured to receive the sensor signal from each of the at least one sensor and to implement an operational data monitoring algorithm configured to store the operational characteristics associated with the sensor signal of each of the at least one sensor in real time in the memory during operation of the rotary electric machine to generate a stored history of the operational characteristics of the rotary electric machine.

Another example includes a rotary electric machine. The device includes at least one heater device arranged within a machine housing associated with the rotary electric machine. The at least one heater device can be configured to provide thermal energy within the machine housing. The device also includes a programmable interface arranged integral with the machine housing. The programmable interface being configured to implement a thermal control algorithm to selectively activate and deactivate each of the at least one heater device in response to at least one predetermined condition.

Another example includes a rotary electric machine. The device includes at least one feedback sensor. Each of the at least one feedback sensor can be configured to provide a sensor signal in a first data format. The sensor signal can provide an indication of a rotation characteristic of the rotary electric machine. The device also includes a programmable interface configured to receive the sensor signal from each of the at least one feedback sensor and to translate the first data format associated with each of the at least one feedback sensor into a second data format associated with a respective type of feedback sensor and to provide at least one output signal in the second data format. Each of the at least one output signal can correspond to the respective rotation characteristic of the rotary electric machine. The programmable interface can include a programming interface port configured to receive a programming input signal that is configured to provide the second data format associated with each of the at least one feedback sensor as any of a plurality of different data formats associated with feedback sensors.

### BRIEF DESCRIPTION OF THE DRAWINGS

FIG. 1 illustrates an example block diagram of a rotary electric machine.

FIG. 2 illustrates an example block diagram of a motor control system.

FIG. 3 illustrates an example block diagram of a programmable interface.

FIG. 4 illustrates an example block diagram of a processor.

FIG. 5 illustrates another example block diagram of a rotary electric machine.

FIG. 6 illustrates another example block diagram of a rotary electric machine.

### DETAILED DESCRIPTION

The present description relates generally to electronic circuits, and specifically to a rotary electric machine with a programmable interface. A rotary electric machine, as described herein, includes a programmable interface that can provide extended functionality of the rotary electric machine, such as implementing operational algorithms and providing dynamic data formats for one or more sensors that are manufactured as a part of the rotary electric machine. As an example, the programmable interface can also be manufactured as a part of the rotary electric machine, such that the programmable interface is fixed to (e.g., mechanically coupled to) or formed integrally with a machine housing of the rotary electric machine. The programmable interface can be configured, for example, to translate a data format associated with at least one sensor associated with the rotary electric machine from a first data format to a second data format, where the first and second data formats are different data formats of a plurality of data formats that are associated with the specific type of sensor of the respective sensor(s).

As an example, the programmable interface can include a programming interface port that enables programming (e.g., a software, firmware, or configuration settings update) of the programmable interface, via an external computer device (e.g., laptop computer, tablet computer, etc.). As described herein, the term “programming interface port” can refer to a physical plug-in port of any of a variety of data formats (e.g., ethernet), or can refer to a wireless transceiver to facilitate wireless communication (e.g., Wi-Fi or Bluetooth) with the programmable interface via the external computer device. Therefore, the signal data format of the sensor data that is output from the programmable interface can be dynamic to facilitate interpretation of any of a variety of data formats by the drive system (e.g., motor drive) or the programmable controller, regardless of the native data format that is output from the respective sensor(s) itself.

In addition, the programmable interface can implement a variety of control algorithms for operating the rotary electric machine. For example, the programmable interface can implement a thermal control algorithm to provide sufficient heat inside the rotary electric machine to protect the rotary electric machine from corrosion. As an example, the thermal control algorithm can be implemented based on temperature data received from one or more environment sensors associated with the rotary electric machine. As another example, the programmable interface can generate real-time operational characteristic data that can be saved in memory as a stored history. Therefore, the stored history can be downloaded (e.g., via the programming interface port) to facilitate troubleshooting of the operation of the rotary electric machine and statistical analysis of the rotary electric machine operation.

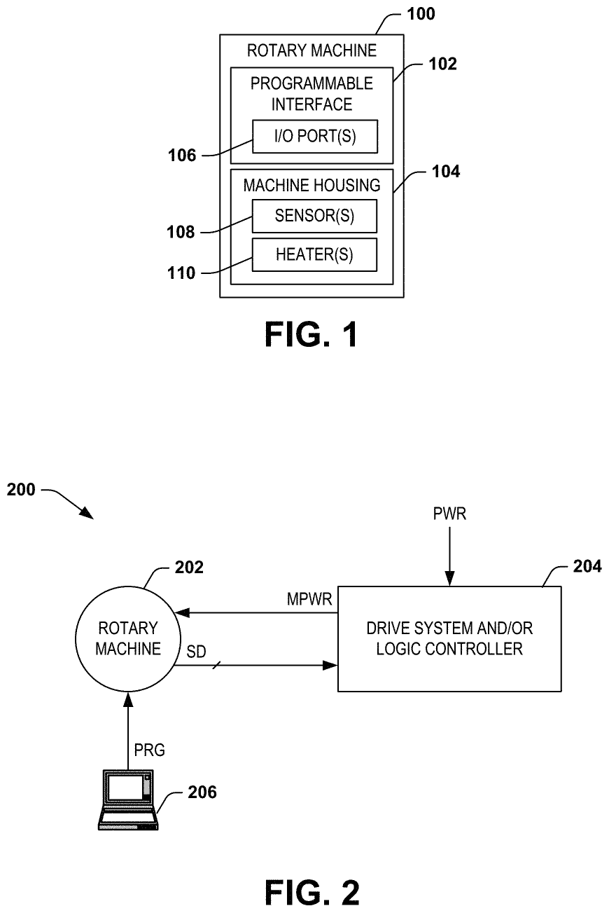

FIG. 1 illustrates an example block diagram of a rotary electric machine (“ROTARY MACHINE”) 100. The rotary electric machine 100 can be implemented in any of a variety of machine control environments that require mechanical motion. The rotary electric machine can be any of a variety of types of motor devices, such as an alternative current (AC) motor (three-phase or single-phase), a direct current (DC) motor, a servo motor, an induction motor, a synchronous wound rotor motor device, a permanent magnet motor, a reluctance motor, or any of a variety of power generator devices. As described herein, the term “rotary electric machine” refers to a motor (or power generator), internal components, external components, mounting features, and electrical connections for receiving power to operate the rotary electric machine 100.

In the example of FIG. 1, the rotary electric machine 100 includes a programmable interface (“PROGRAMMABLE INTERFACE”) 102 and a machine housing 104. The programmable interface 102 includes input and output ports (“I/O PORTS”) 106. For example, the input and output ports 106 can include a variety of different physical configurations (e.g., terminal blocks, wired connections, cable connections, wireless channels, etc.) to accommodate any of a variety of data communication formats. As an example, the programmable interface 102 can correspond to an on-board processing device, such as or including a processor or collection of processors. For example, the programmable interface 102 can be configured as a microcontroller, an application specific integrated circuit (ASIC), a field-programmable gate array (FPGA), a chip-set on a printed circuit board, and/or any other type of processing device configuration.

The machine housing 104 can correspond to the mechanical housing that surrounds, encloses, and/or protects the operational components of the rotary electric machine 100, such as including one or more mechanically coupled enclosure boxes (e.g., junction box(es)). Therefore, as described herein, the inclusion of components of the rotary electric machine 100 as being in the machine housing 104 describes that the components are housed within the machine housing 104 and/or associated junction box(es) or other enclosures thereon. In the example of FIG. 1, the machine housing 104 is demonstrated as including at least one sensor 108 and at least one heater device (“HEATER(S)”) 110. The inclusion of the sensor(s) 108 and heater device(s) 110 in the machine housing 104 is intended to demonstrate that the sensor(s) 108 and heater device(s) 110 are located internally with respect to the machine housing 104. However, the sensor(s) 108 and heater device(s) 110 are not limited to being included internally with respect to the machine housing 104, and the machine housing 104 is not limited to only including the sensor(s) 108 and heater device(s) 110 internally. As an example, the programmable interface 102 can be included at least partially within the machine housing 104 (e.g., within an enclosure box), and/or can be mechanically fixed to the machine housing 104.

The I/O ports 106 can include input ports that are each coupled to one of the sensor(s) 108 to receive a sensor signal associated with each of the sensor(s) 108 that corresponds to the operational characteristic of rotary electric machine 100 as measured by the respective sensor(s) 108. Therefore, each of the input ports can be associated with a respective sensor, and can thus correspond to a sensor channel. For example, the operational characteristic that is monitored by the respective sensor(s) 108 can include any of a variety of parameters, such as voltage, current, speed, position, temperature, power phase, control angle, phase angle, vibration amplitude, coolant flow rate, or any of a variety of other rotary electric machine operational characteristics. For example, a given one of the sensor(s) 108 can correspond to a feedback sensor that is implemented to monitor position and/or rotation characteristics of the rotary electric machine 100, such as position angle and/or rotation speed, to provide drive control of the rotary electric machine 100 (e.g., via a motor drive) in a feedback manner. As an example, each of the sensor(s) 108 can be configured to provide a respective data signal in a first data format that can correspond to a native data format associated with the respective sensor 108 to provide the respective monitored operational characteristic to the programmable interface 102 via a respective input port of the I/O ports 106. As another example, as described in greater detail herein, the sensor(s) 108 can include redundant sensors 108 that can monitor the same rotary electric machine operational characteristics.

The I/O ports 106 also includes output ports that can electrically couple to output signal lines to provide communicative coupling of the programmable interface 102 to an associated control system. Therefore, each of the output ports of the I/O ports 106 can correspond to a sensor channel, and can thus be associated with a respective sensor that is electrically coupled to one of the input ports of the I/O ports. As described herein, the term “associated control system” refers to one or more external control devices, such as a computer system, an associated drive system (e.g., a motor drive or generator controller), and/or an associated logic controller (e.g., programmable logic controller (PLC)). As described herein, the term “output signal line” refers to one or more conductors that form a wire or cable, or a wireless channel, on which a single respective output signal propagates on a respective sensor channel. As described herein, the output ports can provide output signals that correspond to the monitored operational characteristics of the respective sensor(s) 108. As described herein, the programmable interface 102 can be configured to implement a sensor data translation layer to translate the first data format into a second data format for the signal output from each of the sensor(s) 108. As an example, the second data format can correspond to a different data format relative to the first data format, and can be associated with one of a plurality of different data formats associated with the type of sensor of the respective one of the sensor(s) 108.

As described herein, the term “data format” refers to an electrical or logical communication interface in which data provided from a signal is interpreted. The electrical or logical communication interface can thus correspond to a wire, a set of wires, or a cable that propagates an information-carrying signal (e.g., analog, digital, coded, etc.) that communicates the operational characteristic for which the respective sensor(s) 108 provides an indication. As described herein, the terms “first data format”, “second data format”, and “third data format” refer to a data format associated with a sensor type of each respective one sensor of the sensor(s) 108. Therefore, a “first data format” for one sensor of the sensor(s) 108 can be different from a “first data format” for another sensor of the sensor(s) 108, such as based on the one sensor and the other sensor of the sensor(s) 108 being different types of sensors. Similarly, a “second data format” for one sensor of the sensor(s) 108 can be different from a “second data format” for another sensor of the sensor(s) 108, such as based on the one sensor and the other sensor of the sensor(s) 108 being different types of sensors. Therefore, the terms “first data format”, “second data format”, and “third data format” can refer to different data formats for a given sensor type of each of the sensor(s) 108.

As described herein, the sensor data translation layer can be configured to interpret the sensor data provided by the sensor signal in the first data format. In response, the sensor data translation layer can reformat the same sensor data into the second data format and provide the sensor data as an output signal in the second data format from one of the outputs, such that the information provided in the second data format is approximately identical to the information provided in the first data format. However, the approximately identical data is provided in the second data format which can be different from the first data format. Therefore, the sensor data translation layer preserves the information that is provided in the first data format by the sensor signal, and provides the identical information in the second data format or the same first data format (e.g., thus mimicking the first data signal) in the output signal. Therefore, the data that is provided on a sensor channel to one of the input ports of the I/O ports 106 in the first data format can be provided on a respective sensor channel of one of the output ports of the I/O ports 106 in the second data format, which can be a different data coding scheme and/or a different physical or wireless connection arrangement. As another example, the programmable interface 102 is not limited to providing a single output signal in response to a respective sensor signal on a 1:1 basis, but can instead provide multiple output signals (e.g., the same or similar) from a given one sensor signal or can provide one output signal from multiple sensor signals.

As an example, one of the sensor(s) 108 can be a resolver-type position sensor. The resolver-type position sensor can provide an output signal corresponding to a first data signal in a data format that is specific to the resolver-type position sensor data format. The programmable interface 102 can be configured to receive the first data signal as an input (e.g., via an input port of the I/O ports 106). The programmable interface 102 can be configured to interpret the position data from the resolver-type position sensor in the first data format, and to implement a sensor data translation layer. The sensor data translation layer can thus convert the first data format (e.g., resolver-type position sensor data format) into a data format associated with a position sensor of a different type of data format. As another example, the sensor data translation layer can provide the second data format to be the same as the first data format, such that the first data format is mimicked by the second data format.

For example, the sensor data translation layer implemented by the programmable interface 102 can convert the first data format corresponding to a resolver-type position sensor data format into a second data format corresponding to any of a variety of other types of position sensor data formats, such as a quadrature encoder position sensor data format, a SIN/COS position sensor data format, or a BISS-C position sensor data format. The programmable interface 102 can thus provide an output signal from an output port of the I/O ports 106 to provide the position data associated with the rotary electric machine 100 in the second data format. Accordingly, the output signal can be provided on an output signal line to the associated control system (not shown in the example of FIG. 1) to provide the respective operational characteristic of the rotary electric machine 100 (e.g., position, in this example) to the associated control system.

As an example, one of the input ports of the I/O ports 106 can correspond to a programming interface port. The programming interface port can facilitate communicative coupling of an external computer device (e.g., a laptop or tablet device) to the programmable interface 102 to provide updates (e.g., software, firmware, or configuration settings updates). For example, the updates can include changing the second data format of the output signal(s) provided from the I/O ports 106 for the sensor(s) 108. With reference to the example above regarding the resolver-type position sensor, in a first example, the programmable interface 102 can be communicatively coupled to a first drive system that is programmed to interpret position data in a quadrature encoder position data format. Therefore, the programmable interface 102 implements the sensor data translation layer to convert the first data format (e.g., resolver-type position sensor data format) into the second data format (e.g., quadrature encoder position sensor data format). However, further by example, at a later time, the programmable interface 102 can be disconnected from first drive system and communicatively coupled instead to a second drive system that is configured to interpret the SIN/COS position sensor data format. Therefore, an external computer device can be coupled to the programming interface port of the I/O ports 106 to provide an update of the programmable interface 102 to change the sensor data translation layer to instead be configured to convert the first data format (e.g., resolver-type position sensor data format) into a new second data format (e.g., SIN/COS position sensor data format).

In addition to the sensor data translation layer, the programmable interface 102 can also be programmed to implement any of a variety of other types of algorithms. As an example described in greater detail herein, the programmable interface 102 can implement an operational data monitoring algorithm that can correspond to collecting the operational characteristic data from each of the sensor(s) 108 in real-time and generating a stored history of the operation of the rotary electric machine 102. As yet another example described in greater detail herein, the programmable interface 102 can be configured to implement a thermal control algorithm to provide thermal control via the heater(s) 110 to the internal portions of the machine housing 104.

As a result of the sensor data translation layer, the programmable interface 102 can be adapted to provide sensor data to any associated control system in a manner that is agnostic to the data format that is interpreted by the associated control system. Such operation of the programmable interface 102 can provides for a significant improvement over installation of typical motor control systems which requires installation of an associated control system that is compatible with the native sensor data format(s) of the sensor(s) of the respective rotary electric machine. Instead, by installing the rotary electric machine 100, connection of an output signal line to an associated control system and providing an update (e.g., a software, firmware, or configuration settings update) of the programmable interface 102 is all that is required to couple the programmable interface 102, and therefore the rotary electric machine 100, to any associated control systems that can interpret sensor data in any data format(s). Accordingly, any associated control system can be implemented to control the rotary electric machine, even if it is agnostic of the native data formats of the sensor(s) 108. Additionally, the inclusion of the sensor(s) 108 internal to the rotary electric machine 100 provides a significant improvement over installation of typical motor control systems in which sensor(s) are installed external to the rotary electric machine, thereby increasing the chances for damage or errors in the sensor data.

FIG. 2 illustrates an example block diagram of a motor control system 200. The motor control system 200 can correspond to any of a variety of motor control applications for providing mechanical motion. The motor control system 200 includes a rotary electric machine 202 that can correspond to the rotary electric machine 100. Therefore, reference is to be made to the example of FIG. 1 in the following description of the example of FIG. 2.

The motor control system 200 also includes an associated control system 204. As described herein, the associated control system 204 refers to at least one of a drive system device, a computer, and a logic controller for operating the rotary electric machine 200. As a first example, the control of the rotary electric machine 200 can reside entirely within a drive system, entirely within a logic controller, or can be distributed between a drive system and a logic controller. In the example of FIG. 2, the associated control system 204 is configured to receive power, demonstrated as a signal “PWR”. For example, the power PWR can be provided as DC power or AC power (e.g., single phase or three-phase). The associated control system 204 also provides motor power, demonstrated as a signal “MPWR” to the rotary electric machine 202. As an example, the power MPWR can be a conditioned version of the power PWR, stepped up or down in amplitude, phase-changed, and/or altered in form relative to the power PWR (e.g., DC power relative to AC power). For example, the associated control system 204 can be configured to provide or modify the power MPWR to implement control (e.g., activation or deactivation) of the rotary electric machine 202.

In the example of FIG. 2, the associated control system 204 is configured to receive at least one output signal SD corresponding to sensor data. As an example, the rotary electric machine 202 can include at least one sensor (e.g., the sensor(s) 108) that can monitor operational characteristics of the rotary electric machine 202. As described above, the rotary electric machine 202 can include a programmable interface (e.g., the programmable interface 102) that is configured to translate (e.g., via a sensor data translation layer) a first data format associated with a first data signal output from each of the sensor(s) into a second data format corresponding to a different data format relative to the first data format, but being associated with one of a plurality of different data formats associated with the type of sensor of the respective one of the sensor(s). Therefore, the output signal(s) SD can correspond to translated sensor output signal(s) in the second data format to be interpreted by the associated control system 204. Accordingly, the associated control system 204 can operate the rotary electric machine 202 based on the output signal(s) SD, such as based on providing or changing the power MPWR and/or providing any of a variety of other types of control (e.g., posting fault indications, operational data, or any of a variety of other operational schemes) of the rotary electric machine 202.

The motor control system 200 also includes an external computer 206 that can correspond to a laptop, tablet, desktop, supervisory control and data acquisition (SCADA) system, or any other type of computer system. The external computer 206 is demonstrated as providing a programming signal PRG to the rotary electric machine 202. As an example, as described above, one of the input ports of the programmable interface (e.g., the I/O ports 106) can correspond to a programming interface port. The external computer 206 can thus interface with the programming interface port to provide updates of the programmable interface. For example, the updates can include changing the second data format of the output signal(s) SD provided from the programmable interface (e.g., from the I/O ports 106) and/or designating different outputs (e.g., of the I/O ports 106) on which to provide the output signal(s) SD for reconfiguring the sensor channels to the associated control system 204. Therefore, if the associated control system 204 is programmed to accept a specific data format, the update provided via the programming signal PRG can change the data format of the output signal(s) SD provided from the rotary electric machine 202, which can be different from the native data format of the sensor(s) (e.g., the sensor(s) 108) in the rotary electric machine 202 to match the data format interpreted by the associated control system 204 (e.g., from a different output port of the programmable interface).

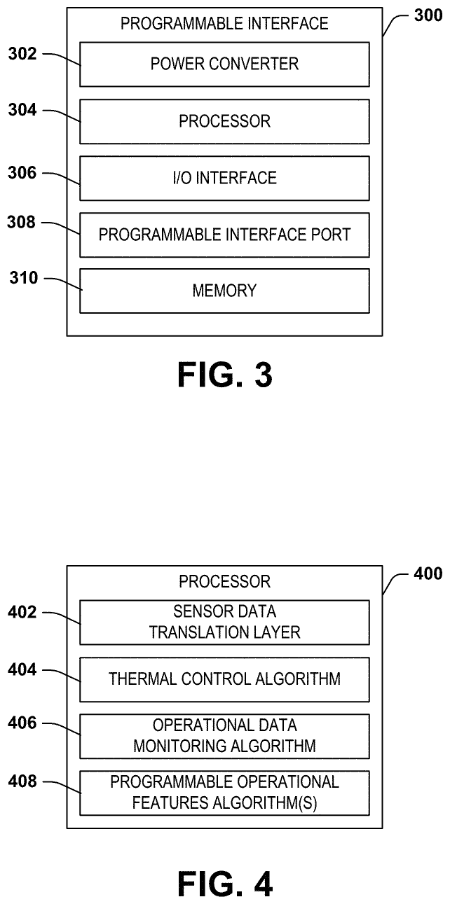

FIG. 3 illustrates an example block diagram of a programmable interface 300. The programmable interface 300 can correspond to the programmable interface 102 in the example of FIG. 1. Therefore, reference is to be made to the examples of FIGS. 1 and 2 in the following description of the example of FIG. 3.

The programmable interface 300 includes at least one power supply 302 (pluralized hereinafter) and a processor 304. The power supplies 302 can correspond to any of a variety of ways to provide operational power to the programmable interface 300. As an example, the power supplies 302 can include or can correspond to a power input port that is configured to receive operational power, such as a DC voltage, directly. As another example, the power supplies 302 can include a step-down transformer that is configured to receive AC power (e.g., single-phase or three-phase) that provides operational power for the rotary electric machine 100, such as the power MPWR. The step-down transformer can thus provide a lower amplitude AC voltage that can subsequently be converted by an AC-DC converter to a DC voltage. For example, the power supplies 302 can include a DC power supply (e.g., 5-50 VDC), an AC power supply (e.g., 90-260 VAC), and/or an input from the motor bus bars (e.g., corresponding to the power MPWR). The processor 304 can correspond to one or more processing elements (e.g., chip(s), FPGA(s), etc.) that can operate based on the DC voltage to provide the processing functions associated with the programmable interface 300.

The programmable interface 300 also includes an I/O interface 306, a programming interface port 308, and a memory 310. The I/O interface 306 can correspond to a portion of the I/O ports 106 in the example of FIG. 1. For example, the I/O interface 306 can include input ports that are coupled to the sensor(s) of the rotary electric machine (e.g., the sensor(s) 108 of the rotary electric machine 100) to receive a sensor signal associated with each of the sensor(s) that corresponds to the operational characteristic of rotary electric machine as measured by the respective sensor(s). As an example, each of the sensor(s) can be configured to provide a respective data signal in a first data format that can correspond to a native data format associated with the respective sensor to provide the respective monitored operational characteristic to the programmable interface 300 via a respective input port of the I/O interface 306.

The I/O interface 306 also includes output ports that can electrically couple to output signal lines to provide communicative coupling of the programmable interface 300 to an associated control system. The output ports of the I/O interface 306 can thus provide output signals that correspond to the monitored operational characteristics of the respective sensor(s). The processor 304 can be programmed (e.g., via a software, firmware, or configuration settings update) to implement the sensor data translation layer described herein. Therefore, the sensor data translation layer can translate the first data format of each of the signal(s) input to the I/O interface 306 into a second data format for each of the output signal(s) provided from the I/O interface 306. Accordingly, an associated control system can interpret the output signal(s) provided from the I/O interface 306 in the predetermined data format associated with the associated control system.

The programming interface port 308 can facilitate communicative coupling of an external computer device (e.g., a laptop or tablet device) to the programmable interface 300 to provide updates, such as to support the sensor data translation layer. For example, the updates can include changing the second data format of the output signal(s) provided from the I/O interface 306 for the sensor(s). Therefore, an external computer device can be coupled to the programming interface port 308 to provide an update of the programmable interface 300 to change the sensor data translation layer to instead be configured to convert the first data format into any of a variety of second data formats, similar to as described above.

The memory 310 can include any of a variety of memory structures (e.g., random access memory (RAM), read-only memory (ROM), flash memory, cache memory for the processor 304, or any other types of non-volatile memory). As an example, the memory 310 can store the sensor data translation layer, such that the processor 304 can access the sensor data translation layer from the memory 310. As another example, the processor 304 can implement an operational data monitoring algorithm. The operational data monitoring algorithm can correspond to collecting the operational characteristic data from each of the sensor(s) in real-time. The operational characteristic data can thus be aggregated to generate a stored history of the operation of the rotary electric machine. As an example, the stored history can be stored in the memory 310, and can thus be accessible via the programming interface port 308. As a result, the stored history can be used to troubleshoot the rotary electric machine and/or to generate a statistical analysis of operation of the rotary electric machine.

FIG. 4 illustrates an example block diagram of a processor 400. The processor 400 can correspond to the processor 304 in the example of FIG. 3. Therefore, reference is to be made to the example of FIG. 3 in the following description of the example of FIG. 4. The block diagram elements of the example of FIG. 4 are intended to illustrate the functional algorithms that can be implemented by the processor 400. As an example, the algorithms described herein can be stored in the memory 310, such that the processor 400 can access and/or operate the algorithms from the memory 310. As described herein, reference to the performance of the functions of the algorithms is interchangeable with respect to the respective algorithm, the processor 400, or the programmable interface in which the processor 400 is included.

The processor 400 is demonstrated as including a sensor data translation layer 402. The sensor data translation layer 402 can be configured, for each of the sensor(s) of the rotary electric machine, to translate the data format of the signals output from the respective sensor and corresponding to an operational characteristic associated with the respective sensor from a first data format to a second data format. As described above, each of the input ports of the programmable interface receives a sensor signal associated with a given one of the sensor(s) of the rotary electric machine. The sensor signal can have a first data format that can correspond to a native data format associated with the respective sensor. The sensor data translation layer 402 can thus translate the first data format into a second data format, such that the programmable interface can provide an output signal in the second data format for each of the sensor(s), as described above in the example of FIG. 2. As also described above, the sensor data translation layer 402 can be dynamic, such that the second data format can be changed (e.g., to a third data format that can be different from the first and second data formats). Such a change in the sensor data translation layer 402 can result from a programming update (e.g., a software, firmware, or configuration settings update) provided from an external computer via the programming interface port.

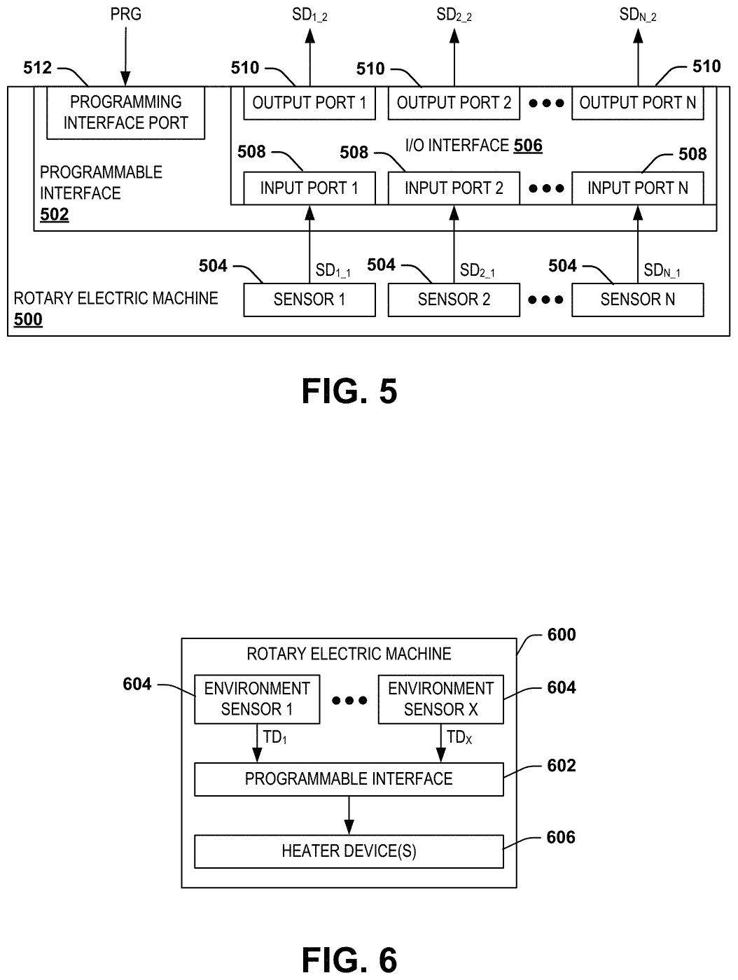

FIG. 5 illustrates another example block diagram of a rotary electric machine 500. The rotary electric machine 500 can correspond to the rotary electric machine 100 or the rotary electric machine 202 in the respective examples of FIGS. 1 and 2. The rotary electric machine 500 is demonstrated in the example of FIG. 5 as including a programmable interface 502. The programmable interface 502 can correspond to the programmable interface 102 or the programmable interface 300 in the respective examples of FIGS. 1 and 2. The programmable interface 502 can be configured to implement the sensor data translation layer 402. Therefore, reference is to be made to the examples of FIGS. 1-4 in the following description of the example of FIG. 5.

The rotary electric machine 500 also includes a plurality N of sensors 504, where N is a positive integer greater than zero. Each of the sensors 504 can be configured to monitor a respective operational characteristic of the rotary electric machine 500, such as speed, position, temperature, power phase, control angle, phase angle, or any of a variety of other rotary electric machine operational characteristics. As an example, more than one of the sensors 504 can monitor the same operational characteristic (e.g., temperature associated with different portions of the rotary electric machine 500). As an example, each of the sensors 504 can be substantially enclosed within or mechanically coupled to a machine housing associated with the rotary electric machine 500. In the example of FIG. 5, each of the sensors 504 is configured to provide a respective sensor signal SD, demonstrated more specifically as signal SD_{1_1} through SD_{N_1}, on separate respective sensor channels corresponding to the respective monitored operational parameter of the rotary electric machine 500. The sensor signal SD of each of the sensors 504 can be provided in a first data format that is associated with a native data format associated with the respective sensors 504. The first data format can be different for each of the sensors 504, such as based on the type of sensor 504 or based on a proprietary data format associated with the manufacturer of the respective sensor 504.

The programmable interface 502 includes an I/O interface 506 that includes a plurality N of input ports 508 and a respective plurality N of output ports 510. As an example, the input ports 508 and the output ports 510 can include a variety of different physical connection types to accommodate a variety of different data formats. Each of the input ports 508 corresponds to a respective sensor channel and receives a respective one of the first data signals SD. As described above in the example of FIG. 4, the programmable interface 502 can implement the sensor data translation layer 402 to convert the first data format of each of the sensor signals SD to a second data format. Therefore, for each of the sensors 504, the sensor data translation layer can convert the first data format of the respective one of the sensor signals SD_{1_1} through SD_{N_1} into a second data format.

Upon translating the first data format of each of the sensor signals SD_{1_1} through SD_{N_1} into the second data format, the programmable interface 502 can provide a respective plurality of output signals SD_{1_2} through SD_{N_2} on the respective output ports 510, with each of the output signals SD_{1_2} through SD_{N_2} being provided with the second data format. Each of the output signals SD_{1_2} through SD_{N_2} can be provided on a separate respective output signal line on a respective sensor channel to an associated control system, such as designated by the sensor data translation layer (e.g., based on configuration settings). Therefore, the associated control system can interpret the operational characteristic of rotary electric machine 500 as provided by the respective sensors 504 in the second data format on a respective output signal line.

In the example of FIG. 5, the programmable interface 502 also includes a programming interface port 512 that can facilitate communicative coupling of an external computer device (e.g., a laptop or tablet device) to the programmable interface 300. In the example of FIG. 5, the programming interface port 512 is demonstrated as receiving a programming signal PRG to provide updates (e.g., software, firmware, or configuration settings updates), such as to support the sensor data translation layer. For example, the updates can include setting and/or changing the second data format of each of the output signals SD_{1_2} through SD_{N_2}, and/or can include designating a given one of the output ports 510 (e.g., associated with the second data format) on which to provide one of the output signals SD_{1_2} through SD_{N_2} corresponding to a respective one of the sensor signals SD_{1_1} through SD_{N_1}. Therefore, an external computer device can be coupled to the programming interface port 512 to provide an update of the programmable interface 502 to change the sensor data translation layer to instead be configured to convert the first data format into any of a variety of second data formats, similar to as described above. Additionally, the programming interface port 512 can provide access to the memory (e.g., the memory 310) of the programmable interface 502, such as to access a stored history of the operational characteristics of the rotary electric machine 500, as described above.

Referring back to the example of FIG. 4, the processor 400 also includes a thermal control algorithm 404. The thermal control algorithm 404 can facilitate control of one or more heater devices (e.g., the heater device(s) 110) within the machine housing of the rotary electric machine to selectively activate and deactivate the heater device(s) based on at least one predetermined condition. For example, the heater device(s) of the rotary electric machine can be configured to maintain an internal temperature of the rotary electric machine above an ambient dew point to mitigate the formation of water condensation inside the rotary electric machine, and therefore to mitigate corrosion within the rotary electric machine. The thermal control algorithm 404 can therefore control activation and deactivation of the heater device(s) in a manner that is both energy efficient and effective to mitigate human error resulting from manual activation of heater device(s).

FIG. 6 illustrates another example block diagram of a rotary electric machine 600. The rotary electric machine 600 can correspond to the rotary electric machine 100 or the rotary electric machine 202 in the respective examples of FIGS. 1 and 2. The rotary electric machine 600 is demonstrated in the example of FIG. 6 as including a programmable interface 602. The programmable interface 602 can correspond to the programmable interface 102 or the programmable interface 300 in the respective examples of FIGS. 1 and 2. The programmable interface 602 can be configured to implement the thermal control algorithm 404. Therefore, reference is to be made to the examples of FIGS. 1-4 in the following description of the example of FIG. 6.

The rotary electric machine 600 is demonstrated as including a plurality X of environment sensors 604, where X is a positive integer greater than zero. As an example, the environment sensors 604 can be distributed throughout the interior of the machine housing of the rotary electric machine 600 to provide individual measurements of environmental conditions inside the rotary electric machine (e.g., inside the machine housing). For example, the environmental conditions can correspond to internal temperature and/or relative humidity of the rotary electric machine 600. Each of the environment sensors 604 is demonstrated as providing a sensor signal TD to the programmable interface 602, wherein the sensor signals are more specifically demonstrated as signals TD₁ through TDₓ. As an example, each of the environment sensors 604 can correspond to sensors 504 in the example of FIG. 5. Therefore, the sensor signals TD can be translated from a first data format to a second data format by the programmable interface 602 via the sensor data translation layer described herein. Therefore, the programmable interface 602 can provide output signals in a second data format for each of the environment sensors 604, as described herein.

In addition, the programmable interface 602 can be configured to monitor the environmental data associated with each of the sensor signals TD. As an example, the thermal control algorithm 404 can evaluate the monitored environmental data provided by the sensor signals TD along with any of a variety of other conditions of the rotary electric machine 600. For example, the other conditions can include the presence or absence of operational power to the rotary electric machine 600, operational status of the rotary electric machine 600, location of the environment sensors 604, ambient dew point, or any of a variety of other factors. The thermal control algorithm 404 can compare the environment data provided by the sensor signals TD individually, or can aggregate the environment data provided by the sensor signals TD based on a statistical analysis (e.g., average, weighted average, etc.). As another example, the thermal control algorithm 404 can only monitor a subset (e.g., proper subset) of the environment data associated with the sensor signals TD. As yet another example, the programmable interface 602 can be configured to identify failed environment sensors 604 and can adjust the thermal control algorithm 404 to implement readings from only the operational sensors.

In the example of FIG. 6, the rotary electric machine 600 also includes one or more heater device(s) 606. The heater device(s) 606 can correspond to any of a variety of electrical heater devices that can be activated to provide thermal energy. As an example, the heater device(s) 606 can be powered by an AC voltage to provide thermal energy based on conducting a large current through a conductor. Based on an evaluation of the environment data provided by the environment sensors 604 via the thermal control algorithm 404, the programmable interface 602 can provide an activation signal ACT to the heater device(s) 606 to activate the heater device(s) 606. Thus, the heater device(s) 606 can provide thermal energy internal to the machine housing of the rotary electric machine 600 to maintain the internal temperature of the rotary electric machine 600 above the ambient dew point. In this manner, the thermal control algorithm 404 can control the internal temperature of the rotary electric machine 600 in a feedback manner.

As an example, the programmable interface 602 can also be configured to monitor the power that is provided to activate the heater device(s) 606. For example, the power to the heater device(s) 606 can be monitored via a sensor (e.g., one of the sensor(s) 108) as a monitored operational characteristic of the rotary electric machine 600. The programmable interface 602 can thus mitigate electromagnetic interference (EMI) based on the monitored AC voltage. For example, in response to identifying a request for activation of the heater device(s) 606, such as based on the identifying that the temperature(s) provided by the environment sensors 604 via the sensor signals TD decreases less than the predetermined temperature threshold, the thermal control algorithm 404 can delay providing the activation signal ACT until the monitored AC voltage exhibits a zero-crossing. In response to detecting the zero-crossing of the AC voltage, the programmable interface 602 provides the activation signal ACT. As a result, the AC current through the heater device(s) 606 can increase more gradually, as opposed to exhibiting a large inrush current based on the AC voltage being at or near a peak amplitude. Accordingly, the activation of the heater device(s) 606 can be performed in a manner that mitigates spurious EMI.

As another example, the thermal control algorithm 404 can be implemented to control the operation of the heater device(s) 606 based on the operational status of the rotary electric machine 600. For example, the programmable interface 602 can determine whether the rotary electric machine 600 is activated (e.g., via being provided operational power). In response to determining that the rotary electric machine 600 is powered and/or rotating, the thermal control algorithm 404 can deactivate the heater device(s) 606 automatically, given that the heater device(s) 606 are likely unnecessary during operation of the rotary electric machine 600. Therefore, the thermal control algorithm 404 can alleviate potential operator error that can result from a user forgetting to manually deactivate the heater device(s) 606, such as can occur in a typical rotary electric machine control environment, thereby mitigating the possibility of damaging the rotary electric machine 600.

Referring back to the example of FIG. 4, the processor 400 also includes an operational data monitoring algorithm 406. The operational data monitoring algorithm 406 can correspond to collecting the operational characteristic data from each of the sensor(s) in real-time and storing the operational characteristic data in a timeline during operation of the rotary electric machine. The operational characteristic data can thus be aggregated to generate a stored history (e.g., stored history data file) of the operation of the rotary electric machine. The stored history can thus be continuously modified during operation of the rotary electric machine, and can thus include all of the monitored operational data from initial operation of the rotary electric machine and/or from a reset time to a present time. As an example, the stored history of the monitored operational data can also include a fault history or set of fault conditions that have occurred during operation of the rotary electric machine.

As an example, the stored history can be stored in the memory, and can thus be accessible via the programming interface port via an external computer device, as described herein. Therefore, a user can view the stored history as a static file in a variety of different data formats (e.g., Portable Document Format (PDF)) that can be saved on the external computer device and/or transmitted form the external computer device over a network. The static file can thus correspond to a history of the operational characteristics of the rotary electric machine up to a time of download of the stored history onto the external computer device. As another example, the stored history can be accessed and monitored in real time from the programming interface port via the external computer device. Therefore, the user can monitor the operational characteristics in real time as the rotary electric device operates on the external computer device via the programming interface port. As a result, in either example, the stored history can be used to troubleshoot the rotary electric machine and/or to generate a statistical analysis of operation of the rotary electric machine.

The processor 400 further includes one or more programmable operational features algorithms 408. The programmable operational features algorithms can correspond to one or more algorithms for controlling the rotary electric machine based on the processing capability of the processor 400. As an example, the processor 400 can provide additional control schemes for redundant sensor(s). For example, the programmable interface can provide the output signal associated with one of the redundant sensors, and in response to the processor 400 detecting failure of the respective sensor, can switch to providing the output signal from a different one of the redundant sensors. The processor 400 can thus also post a fault indication associated with the failed sensor(s). As another example, the processor 400 can be configured to provide the rotary electric machine operational characteristic data in a given one of the output signals as a statistical combination of multiple redundant sensors. For example, a given one of the output signals can be provided as an average (e.g., flat or weighted) of the output signals of multiple redundant sensors, or as part of a voting scheme, such as based on an average or combination of similar amplitude readings while excepting anomalous readings. As yet another example, the processor 400 can exhibit more local control of functions that are traditionally performed in an associated control system. Given the ability of the processor 400 to be programmed in any of a variety of ways to exhibit control schemes of the rotary electric machine, the programmable operational features algorithm(s) 408 can be any of a variety of control algorithms for operating the rotary electric machine.

What have been described above are example embodiments. It is, of course, not possible to describe every conceivable combination of components or methodologies for purposes of describing the embodiments, but one of ordinary skill in the art will recognize that many further combinations and permutations of the embodiments are possible. Accordingly, the embodiments are intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A rotary electric machine device comprising:
at least one sensor, each of the at least one sensor being configured to provide a sensor signal in a first data format, the sensor signal providing an indication of a respective one of a plurality of operational characteristics of the rotary electric machine; and
a programmable interface configured to receive the sensor signal from each of the at least one sensor and to translate the first data format associated with each of the at least one sensor into a second data format associated with a respective type of sensor corresponding to the respective at least one sensor and to provide at least one output signal in the second data format, each of the at least one output signal corresponding to at least one of the operational characteristics.

2. The device of claim 1, wherein the programmable interface comprises a programming interface port configured to receive a programming input signal that is configured to provide the second data format associated with each of the at least one sensor as any of a plurality of different data formats associated with the respective type of sensor corresponding to the respective at least one sensor.

3. The device of claim 2, wherein the programmable interface further comprises a non-volatile memory configured to store the operational characteristics provided by the at least one output signal, wherein the programming interface port is further configured to provide access to the operational characteristics.

4. The device of claim 1, wherein the rotary electric machine further comprises a power input for providing operational power to the rotary electric machine, wherein the programmable interface comprises a power supply to provide power to the programmable interface from the power input.

5. The device of claim 1, wherein the at least one sensor is located within a machine housing of the rotary electric machine.

6. The device of claim 1, wherein the programmable interface is mechanically fixed to or integral with a machine housing of the rotary electric machine.

7. The device of claim 1, wherein the rotary electric machine further comprises a heater device within a machine housing associated with the rotary electric machine, wherein the programmable interface is configured to implement a thermal control algorithm to provide thermal energy within a machine housing via the heater device.

8. The device of claim 7, wherein the at least one sensor comprises at least one environment sensor configured to monitor a local temperature of the rotary electric machine within the machine housing, wherein the programmable interface is configured to implement the thermal control algorithm in response to the monitored local temperature associated with each of the at least one environment sensor in a feedback manner, and is further configured to provide the monitored local temperature associated with each of the at least one environment sensor as a respective at least one of the at least one output signal in the second data format.

9. The device of claim 1, wherein the at least one sensor comprises a plurality of redundant sensors, wherein the programmable interface is configured to receive the sensor signal from each of the redundant sensors and to provide one output signal associated with the operational characteristics of at least one of the redundant sensors in the second data format.

10. The device of claim 9, wherein the at least one sensor comprises a plurality of redundant sensors, wherein the programmable interface is configured to provide the one output signal associated with the operational characteristics of one of the redundant sensors in the second data format, to identify a fault condition associated with the respective one of the redundant sensors, and to provide the one output signal associated with the operational characteristics of a different one of the redundant sensors in the second data format in response to identifying the fault condition.

11. A rotary electric machine device comprising:
at least one sensor, each of the at least one sensor being configured to provide a sensor signal providing an indication of a respective one of a plurality of operational characteristics of the rotary electric machine; and
a programmable interface comprising a non-volatile memory, the programmable interface being configured to receive the sensor signal from each of the at least one sensor and to implement an operational data monitoring algorithm configured to store the operational characteristics associated with the sensor signal of each of the at least one sensor in real time in the memory during operation of the rotary electric machine to generate a stored history of the operational characteristics of the rotary electric machine.

12. The device of claim 11, wherein the programmable interface comprises a programming interface port configured to provide access to the stored history via an external computer device.

13. The device of claim 12, wherein the operational data monitoring algorithm is further configured to store the stored history as a file that is downloaded to the external computer device via the programming interface port.

14. The device of claim 12, wherein the operational data monitoring algorithm is further configured to provide real-time monitoring of the operational characteristics on the external computer device via the programming interface port.

15. The device of claim 11, wherein the rotary electric machine further comprises a power input for providing operational power to the rotary electric machine, wherein the programmable interface comprises a power supply to provide power to the programmable interface from the power input.

16. The device of claim 11, wherein the at least one sensor is located within a machine housing of the rotary electric machine.

17. A rotary electric machine device comprising:
at least one heater device arranged within a machine housing associated with the rotary electric machine, the at least one heater device being configured to provide thermal energy within the machine housing; and
a programmable interface arranged integral with the machine housing, the programmable interface being configured to implement a thermal control algorithm to selectively activate and deactivate each of the at least one heater device in response to at least one predetermined condition.

18. The device of claim 17, further comprising at least one environment sensor, each of the at least one environment sensor being configured to provide a sensor signal providing an indication of an environmental condition within the machine housing, wherein the programmable interface is configured to implement the thermal control algorithm in response to the monitored local temperature associated with each of the at least one environment sensor in a feedback manner.

19. The device of claim 18, wherein the at least one predetermined condition comprises operational status of the rotary electric machine device, at least one measurement provided by the respective at least one environmental sensor, and operational power provided to the rotary electric machine device.

20. The device of claim 17, wherein the rotary electric machine further comprises a power input for providing alternating current (AC) power to the heater device, wherein the thermal control algorithm comprises monitoring a waveform associated with the AC power and activating the heater device at an approximate zero-crossing of the waveform in response to the thermal control algorithm identifying a demand for the thermal energy.

21. A rotary electric machine device comprising:
at least one feedback sensor, each of the at least one feedback sensor being configured to provide a sensor signal in a first data format, the sensor signal providing an indication of at least one of a position characteristic and a rotation characteristic of the rotary electric machine; and
a programmable interface configured to receive the sensor signal from each of the at least one feedback sensor and to translate the first data format associated with each of the at least one feedback sensor into a second data format associated with a respective type of feedback sensor and to provide at least one output signal in the second data format, each of the at least one output signal corresponding to the respective rotation characteristic of the rotary electric machine, the programmable interface comprising a programming interface port configured to receive a programming input signal that is configured to provide the second data format associated with each of the at least one feedback sensor as any of a plurality of different data formats associated with feedback sensors.

22. The device of claim 21, wherein the at least one feedback sensor is located within a machine housing of the rotary electric machine.

23. The device of claim 21, wherein the programmable interface is mechanically fixed to or integral with a machine housing of the rotary electric machine.

24. The device of claim 21, further comprising a power input to the rotary electric machine device configured to receive operational power from a drive system to operate the rotary electric machine, wherein the at least one output signal is provided to the drive system for feedback control of the rotary electric machine device via the power input in a feedback manner.
